(19) United States
(12) Patent Application Publication
(10) Pub. No.: US 2005/0177574 A1
(43) Pub. Date: Aug. 11, 2005

(54) Electronic course generation systems and methods

(76) Inventors: James Riley, Fort Lauderdale, FL (US); Patrick Toomey, Sunrise, FL (US)

Correspondence Address: Patricia E. McQueeney, Esq.;Becker & Poliakoff, P.A., 3111 Stirling Road, Fort Lauderdale, FL, 33312, US

(21) Appl. No.: 11/098,132

(22) Filed: Apr. 4, 2005

Related U.S. Application Data
(63) Continuation-in-part of application No. 09/637,388, filed on Aug. 11, 2000.
(60) Provisional application No. 60/203,180, filed on May 8, 2000.

(51) Int. Cl. G06F 17/30

(52) U.S. Cl. 707/10

(57) ABSTRACT

One aspect of the present invention provides an annotation tool for use in conjunction with computer generated documents. The annotation tool enables the user to copy portions of the document or enter personalized notes in annotation field. The notes may be specific to particular page of the document and may include a reference to the page at which the notes were taken. Another aspect of the present invention allows authors to create their own instructional programs and receive revenue for publishing their courses on the Internet.

This application is a continuation-in-part of U.S. application Ser. No. 09/637,388, filed Aug. 11, 2000, currently pending, which claims priority to U.S. provisional application Ser. No. 60/203,180, filed May 8, 2000, now abandoned.

### BACKGROUND OF THE INVENTION

This invention relates to electronic document systems. More particularly, the invention relates to note taking methods and systems that may be used in conjunction with computer-based interactive learning programs. It also relates to methods for creating, publishing, and receiving revenue from computer-based interactive learning programs.

The Internet comprises a vast number of computers and computer networks that are interconnected through communication links. The interconnected computers exchange information using various services, such as electronic mail (e-mail), and the World Wide Web (“WWW” or “Web”). The Web service allows a server computer system (i.e., a server of Web site) to send graphical Web pages of information to a remote client computer system. The remote client computer system may then display the Web pages. Each resource (e.g., computer or Web page) is uniquely identifiable by a Uniform Resource Locator (“URL”). To view a specific Web page, a client computer system specifies the URL for that Web page in a request, such as a Hyper Text Transfer Protocol (“HTTP”) request. The request is forwarded to the Web server that supports that Web page. When that Web server receives the request, it sends that Web page to the client computer system. When the client computer system receives that Web page, it typically displays the Web page using a browser. A browser is usually a special-purpose application program that requests and displays Web pages.

Currently, Web pages are typically defined using Hyper Text Markup Language (“HTML”). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls and other features. The HTML document may contain URLs of other Web pages available on that server computer system or other server computer systems.

The Web is well suited for providing educational programs to users located all over the world. Web sites have recently emerged to which students may “log on” and participate in various learning programs available therein. Many educators realize that this form of instruction is close to having a personalized instructor for each student, which is viewed by many as the ideal learning environment. Accordingly, in order to provide a better learning environment that more closely approaches the ideal environment, many educators are turning to computers and the Internet. Through the use of computers, learning programs may be developed that provide both instruction and feedback virtually simultaneously. For example, a general course of instruction may be presented to an individual after which the computer may query the individual regarding the principles just learned. The computer can then tally the score and provide the score to the individual. This allows the individual to return to information not learned and review that material again. Another advantage of computers is that they allow the pace of instruction to be varied according to the ability of the individual to learn. Furthermore, computers with Internet access can be used to enhance personal learning outside the traditional “bricks and mortar” educational environment. Computers thus hold great potential for enhancing the learning environment.

Current utilization of computers as part of the learning environment includes the use of tutorial-style programs to teach a wide array of skills. With the advent of educational Web sites, “distance learning” is now possible through educational programs available at certain Web site. One such Web site is Learn.com located at http://www.Learn.com, the assignee of this application. At the Leam.com Web site, a user may log on and select from among a variety of free educational programs to learn a certain skill or subject.

Computer programs designed to aid in the learning process typically first present a section of information and then test the individual based on the information presented. The structures of these programs are generally organized in a preset or predefined manner. Thus, like text books generally utilized in educational settings, the educational program presents a chapter of information and then quizzes the user on the information contained in that chapter. The next chapter is then presented, if any, along with the associated test.

One shortcoming of many prior educational programs is that they fail to provide the student user with a note taking feature that can annotate the educational program with personalized course notes that refer back to a particular portion of the program. As a result, if a user decides to go back and review a certain portion of the program, he or she may have to pass through a significant amount of information which is already known.

Another shortcoming of current computer-based educational programs is related to revenue generation. As with other business concerns, educators wish to be paid for the work required to generate such educational programs. In the past, individual authors had essentially two choices if they wanted to publish educational programs on the Internet: 1) contact the proprietor of an Internet site and post the program on that site's server; or 2) post the program on the Internet themselves for free. In the first instance, the educator was often paid a flat fee for his or her work, and in the second instance the author was often not compensated at all. No mechanism existed that allowed the educator to be compensated for his or her work based on popularity.

Thus, in view of the foregoing, it would be desirable to provide an annotation tool that allows the user to annotate documents with personalized course notes that refer back to a particular portion of the document. It would also be desirable to provide computerized course generation and revenue sharing methods that allow authors to create, publish, and receive revenue for their educational programs based on course popularity.

### SUMMARY OF THE INVENTION

It is therefore an object of the present invention to provide an annotation tool that allows the user to annotate documents with personalized course notes that refer back to a particular portion of the program.

It is another object of the present invention to provide an annotation tool that allows users to annotate electronic documents of any kind, whether or note related to courses, with annotations that are stored and searchable by other parties.

It is another object of the present invention to provide computerized course generation and revenue sharing methods that allow authors to create and publish educational programs and to receive revenue for those programs based on their popularity.

In accordance with these and other objects of the present invention, annotation and educational course generation methods are provided. One aspect of the invention provides an annotation tool for use in conjunction with computer generated documents. Such methods are described, for example, in Riley et al. U.S. provisional application No. 60/203,180, which is hereby incorporated by reference in its entirety. The annotation tool enables the user to copy selected portions of the document or to enter personalized notes in an annotation field. The notes may be specific to a particular page of the document and may include a reference back to the page at which the notes were taken.

Another aspect of the present invention allows users to annotate electronic documents of any kind. The annotations are saved and are searchable by other users. The annotations may be associated with the annotated documents.

Another aspect of the present invention allows authors to create their own educational programs and receive revenue for publishing their courses on the Internet.

### BRIEF DESCRIPTION OF THE DRAWINGS

The above and all other objects and advantages of the present invention will be apparent upon consideration of the following detailed description, taken in conjunction with accompanying drawings, in which like reference characters refer to like parts throughout, and in which:

FIG. 1 is an illustrative example of a listing from which a user may choose a certain category of documents.

FIG. 2 is an illustrative example of a category listing form which a user may choose a certain document.

FIG. 3 is an illustrative example of a document showing one possible embodiment of an annotation field in accordance with the principles of the present invention.

FIG. 4 is an illustrative example of a document showing the annotation field of FIG. 3 in use.

FIG. 5 is an illustrative example of a course notes summary in accordance with the principles of the present invention.

FIG. 6 shows the annotation field of the present invention in a collapsed state and icon for recalling the annotation field.

FIG. 7 is an illustrative example of a document showing a link to a course authoring utility of the present invention.

FIG. 8 is another illustrative example of a document showing a link to the course authoring utility of the present invention.

FIGS. 9-14 are screen displays generated by the course authoring utility of FIGS. 7-8.

FIG. 15 is another illustrative example of a document showing a link to the author's control center.

### DETAILED DESCRIPTION OF THE PREFERRED EMBODIMENT

One embodiment of the present invention provides a method and tool for annotating computer-based documents. Such documents may include, but are note limited to, spreadsheet documents, documents generated by word processor programs such as WordPerfect™ or Microsoft Word™, Internet documents such as Web pages or potions of Web pages, or any other suitable computer compatible or computer-based document. Such document may include text-based information, graphical information, or video information, or a combination thereof.

In one embodiment of the present invention, the annotation tool may be a “stand alone” computer program that can be invoked by a user and associated with a particular document. For example a user working in a word processor document may call an externally located annotation tool for use with that document. In other embodiments, however, the annotation tool may be resident within the application program currently in use. A user browsing a Web page, for example, may invoke an annotation tool that is resident at the Web site. If desired, the annotation tool may be configured such that it automatically becomes active whenever a user enters a specific document or Web site.

Notes or other annotations may include any suitable content. For example, notes or annotations my include text, graphics, video, audio, animations, any other suitable content, or a combination thereof. Notes or other annotations may be stored in any suitable format using any suitable storage device or combination of formats and devices. For example, notes or other annotations may be stored in a database, as separate documents using suitable document management software, or using any other suitable approach. The notes or other annotations may be stored on, for example, hard-disks, floppy disks, tapes, recordable optical storage media, in RAM, or any other suitable storage device. If desired, pointers, links, universal resource locators (URLs), identifiers, or other indicators of source documents (e.g., word processing documents, spread sheets, web pages, etc.) may be stored to associate notes or other annotations with source documents.

In some embodiments of the present invention, notes or other annotations may be stored at a server (e.g., on an Internet server, application server, or other server). This allows users to access their notes or other annotations regardless of the users' locations. In some embodiments the notes or other annotations may be stored on a storage device at the users' locations, or on both a server and a storage device at the users' locations.

The notes may be searchable. For example, user may use well-known “find” features to find particular strings in the notes. In another suitable approach, users may search notes using known web-searching techniques. For example, the annotation feature of the present invention may allow users to annotate web pages. The system may store the notes to create a searchable notes database for web pages. Notes may be made available for searching by any user using a web browser. The system may allow users to, for example, search all of the available notes of the web documents for desirable information using, for example, a web browser and known web searching techniques.

The system may allow users to access electronic documents associated with the annotations using any suitable approach. For example, the system may allow users to access associated web documents based on URLs stored with or separately from the notes. As another example, the system may allow users to access associated documents stored on computers based on references stored with or separately from notes.

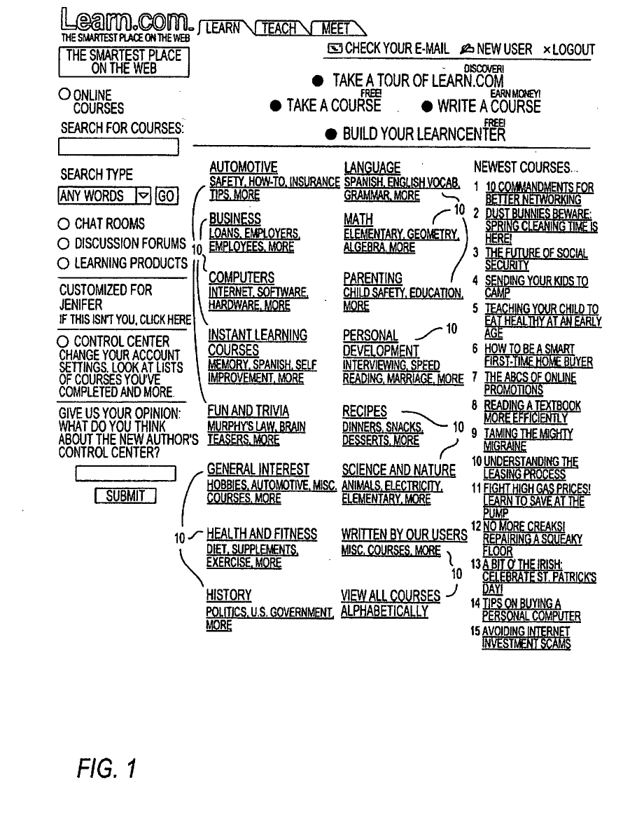

Broadly speaking, a user may enter a document or browse a certain Web page. This is generally depicted in FIG. 1 wherein a user is browsing the home page the Learn.com Web site. Next, the user may select a particular category of documents to view from a group of categories 10. In this particular example, the user is selecting a program from a group of educational programs (courses) available at the Leam.com Web site. It will be understood, however, that users may select from any list of computer-based documents. For example, document selection may occur from a group of word processor files.

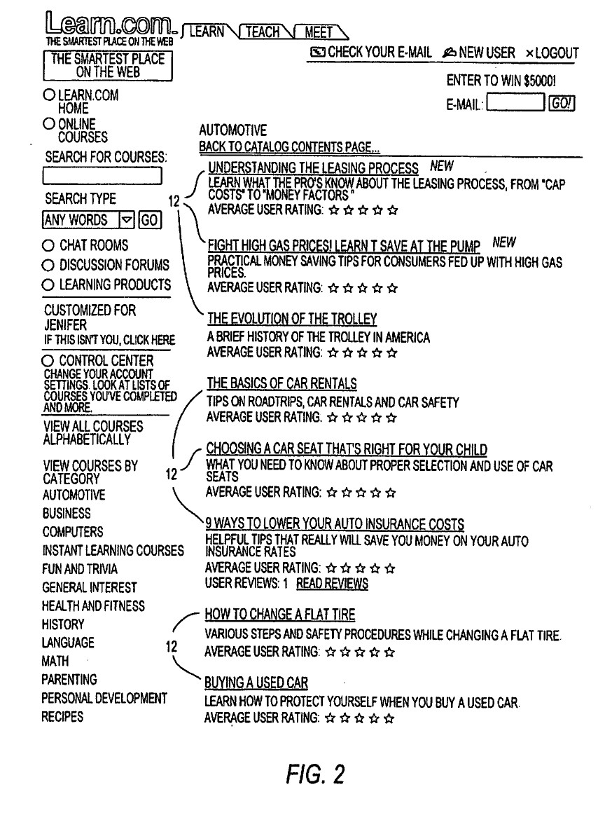

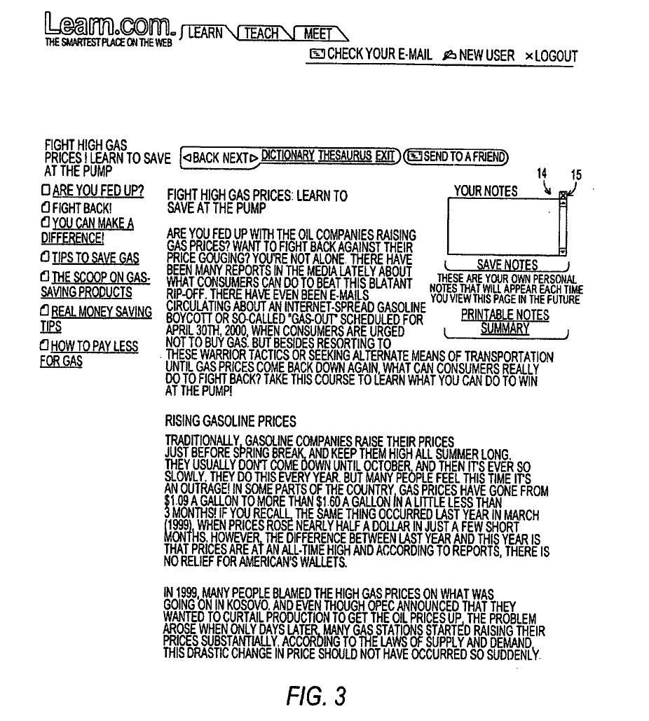

FIG. 2 shows list of courses 12 available in the “Automotive” category listed in FIG. 1. Assuming the second listing, Fight High Gas Prices is selected, the course shown in FIG. 3 is displayed. Observe the “Your Notes” annotation field 14 displayed in the upper right hand corner. As mentioned above, annotation field 14 may be generated automatically upon entering the course or may be invoked by selecting a menu option (not shown). Once annotation field 14 is displayed, the user may enter any type of graphical or text-based notes therein. For example, the user may copy and paste information from the displayed page to annotation field 14, or may type or write his or her own personalized information. Hereinafter, the term “notes” will be used to describe any such information entered into the annotation field.

Notes entered into the annotation field may be course specific, page specific, or both. That is, if the user is browsing course notes generated from annotation field 14 (discussed in more detail below), the notes may contain a reference back to the portion of the document where the notes were taken. This may include a link back to the course page or a listing of the chapter and page number of the document (if applicable).

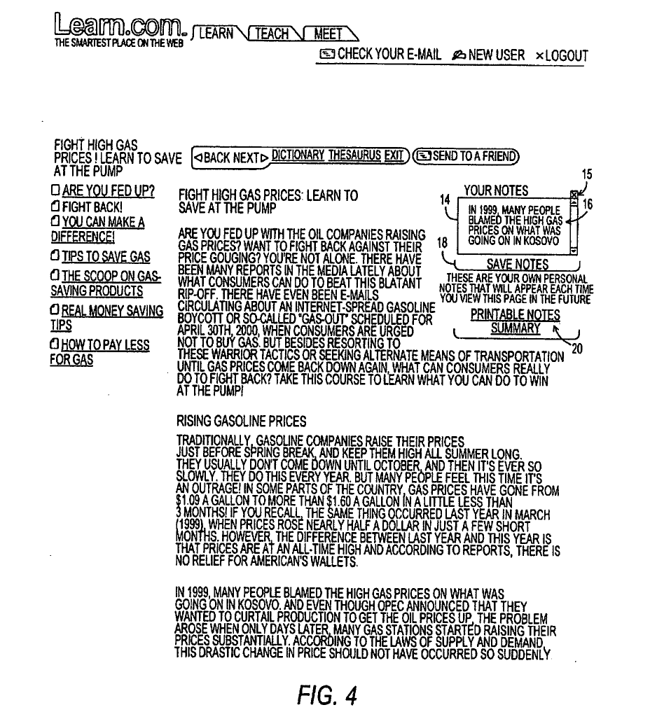

Using the arrangement shown in FIG. 4, the user may review and edit information in annotation field 14. This may be accomplished, for example, by using scroll bar 16 on the right hand side of annotation field 14 to arrive at a particular point in the notes. Once at the desired point, various known editing procedures may be performed. In some embodiments, annotation field 14 may only contain information that was entered with respect to a displayed page. For example, each displayed page may have its own dedicated annotation field 14. In this case, the user may only review and edit a section of the notes that refer to a particular page of the course. Thus, if it is desired to edit notes that refer to another page, the user must go to that page. In another embodiment, however, annotation field 14 may be continuous so that the entirety of the notes taken may be viewed and/or edited simply by using scroll bar 16. Such features may be selectable by the user.

As shown in FIG. 4, a user may save the notes in annotation field 14 by clicking the on-screen “Save Notes” button 18 located just below annotation field 14. The save feature may be user-defined so that it is page specific, saves a portion of the course notes, or is cumulative for the course. The information in annotation field 14 may also be saved in sequential order. This allows the user to print either a portion or a complete copy of the course notes arranged in a “first-in, first-out” sequential order. If desired, however, the notes may also be arranged in a user-defined order and then saved and/or printed.

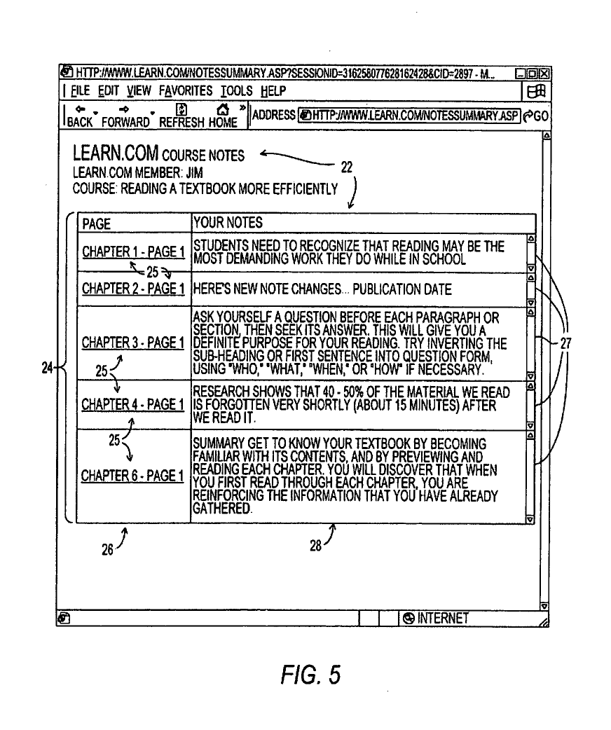

A user may generate a summary of the course notes by clicking on link 20 entitled “Printable Notes Summary” located below the “Save Notes” button 18 (FIG. 4). As shown in FIG. 5, course notes summary 22 may be arranged in a table format which includes a sequential listing 24 of the information entered in annotation field 14. This information may be arranged by chapter or section (if applicable) and by page number if desired. In other embodiments, the information contained in or the arrangement of the contents of course notes summary 22 may be user-defined (not shown). Summary 22 may also include the name of the course user as well as the course or document title.

To provide simple and efficient access points to the course or document, course notes summary 22 may supply the user with a link 25 back to the document page on which it the note was taken. This is shown in FIG. 5 wherein links 25 to the chapter and page number of the notes are contained in “Page” column 26 on the left-hand side of the page. Simply clicking on link 25 brings the user back to the point in the course where the note was taken. This allows the user to quickly return to a specific point in the course or document. Notes that are updated within a course are preferably automatically updated as part of the course notes summary.

Users may also scroll through notes for a particular chapter in course summary 22 using a scroll bar 27 located at the right hand side of the “Your Notes” column 28 (shown in FIG. 5). The page reference may automatically update to reflect the page at which the note currently shown was taken.

In an Internet-based embodiment of the present invention, notes information associated with a particular course may be stored at the course provider's location (e.g., the course provider's Internet server). This allows the user to access his or her notes information every time the course is revisited regardless of the user's location. In some embodiments, however, a user may be able to store a version of the notes at his or her location. This enables the user to copy and access the notes when not using the original document or course.

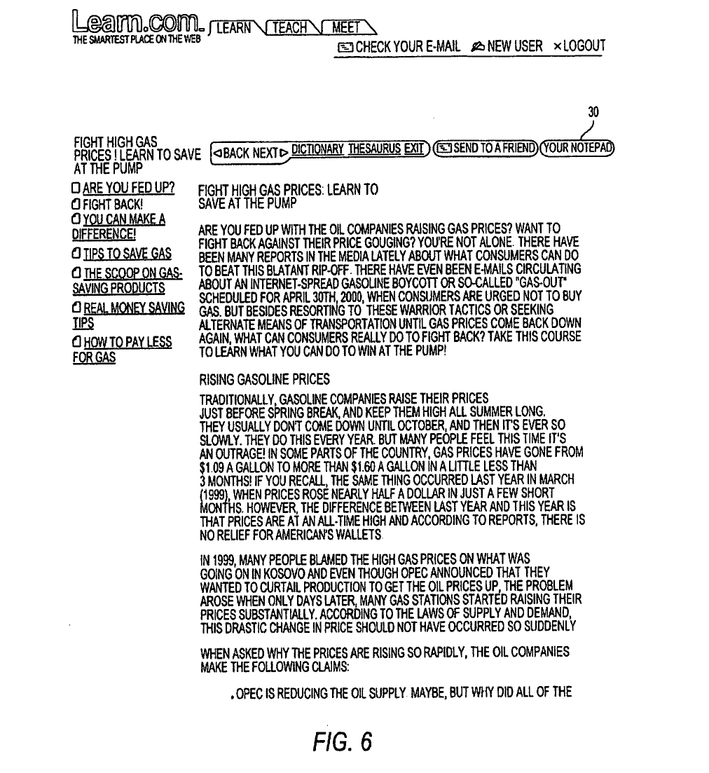

If desired, the user may “turn off” the annotation field by clicking on the X (designated as reference numeral 15) in the upper right hand corner of annotation field 14 (shown in FIGS. 3 and 4). This collapses annotation field 14 to an icon 30 at the top of the screen called “Your Notepad” (shown in FIG. 6). At any time while in the course the user may simply click on the “Your Notepad” icon 30 to return annotation field 14.

In embodiments where the notes information is considered to be proprietary, only the author or other designated party (e.g., the course administrator, system provider, or other party) may have access to that information. In other embodiments, the course provider may have sample notes or a course instructor's notes available to the public. If desired, the system may allow users to set whether their notes may be accessed by other parties. In another suitable approach, the system may make access to users' notes mandatory.

Course authors or other designated parties with access to the stored notes may use the notes to improve the course or for other purposes. For example, the course notes may act as implicit feedback from course participants. This implicit feedback may provide insight into course effectiveness, how users relate to courses, or other feedback that the course author may use to improve the course. The implicit feedback may provide course authors with insight into what users are struggling with, concerned about, like or dislike, that a canned request for explicit feedback might note provide. If desired, the implicit feedback of the notes might be used in conjunction with explicit feedback from users. The explicit feedback may be within or separate from the notes.

Authors or other designated parties may use the notes as feedback to target users with suggestions, advice, or products. For example, an author may examine notes to determine if students are grasping concepts, to see how quickly users are going through the course, or if students have omitted important concepts from their notes. The author may provide information to the users using, for example, e-mail or other system messages. Authors or other parties may review notes to determine whether courses should be discontinued, or whether users require other courses that are not yet provided. The system may, for example, generate user profiles based on note content using known profiling techniques, and target advertisements to the users. Any other use of the notes as feedback may also be performed.

Another aspect of the present invention involves methods that allow authors to create their own instructional programs and receive revenue for publishing their courses on the Internet. Generally speaking, an author creates an instructional course or educational program (course) and submits it for free or fee-based publication on the Internet. Internet users may then access a Web site where the instructional program is located and “take the course.” Authors are compensated for their work based on the popularity of the course they submit for publication. One method of compensating authors is by sharing fees collected from the course users. Another is by sharing a portion of the advertising revenue generated by their course. Such advertising may be located on some or all of the course pages. A Web site proprietor and the course author may share advertising revenue generated by that course, for example, on 70% to 30% basis, respectively.

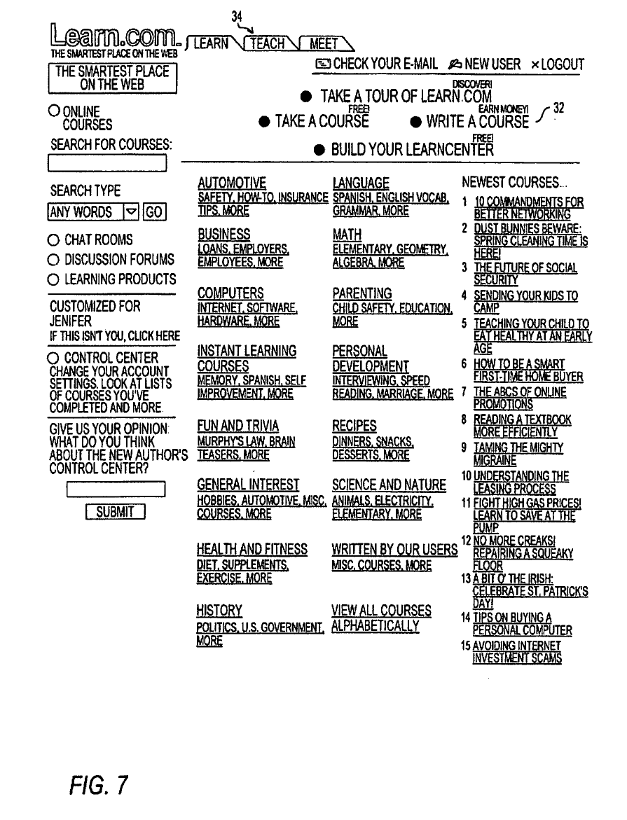

In order to motivate authors to create courses, it is generally desirable to make this process and the method of compensation as simple and efficient as possible. FIG. 7 shows the Learn.com home page that includes a “Write a Course” utility that helps authors generate and submit instructional courses for Internet publication. As shown in FIG. 7, an author may choose either a “Write a Course” link 32 or a “Teach” menu option 34 to begin writing a course. At this point the author may be presented with legal documents such as an “Author's Agreement” and a “Terms and Condition for Use” contract that define the business relationship and publication rights of the author and the Web site proprietor (not shown).

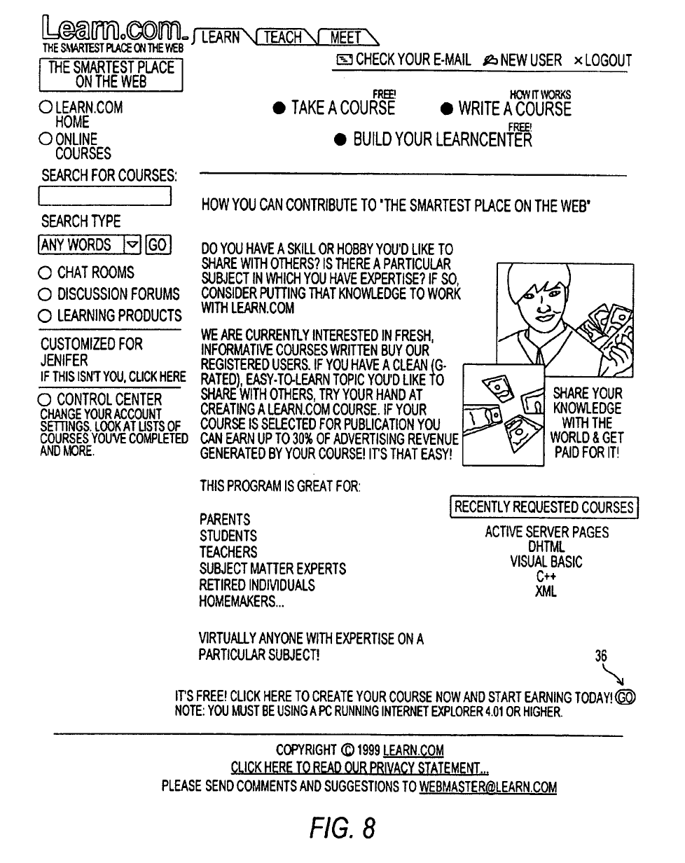

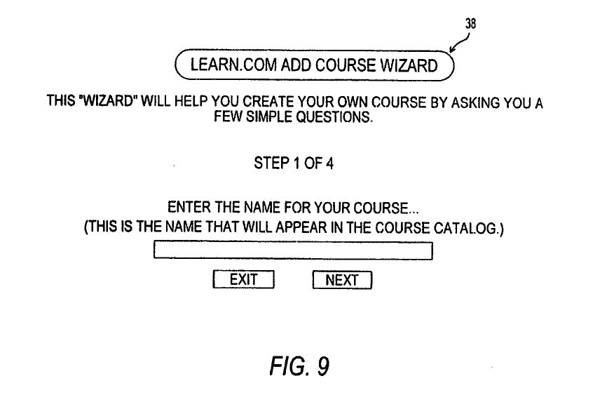

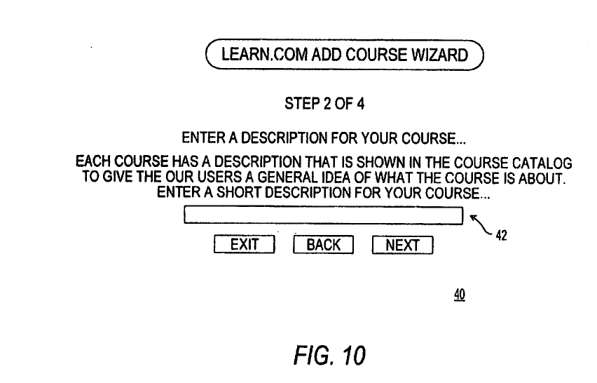

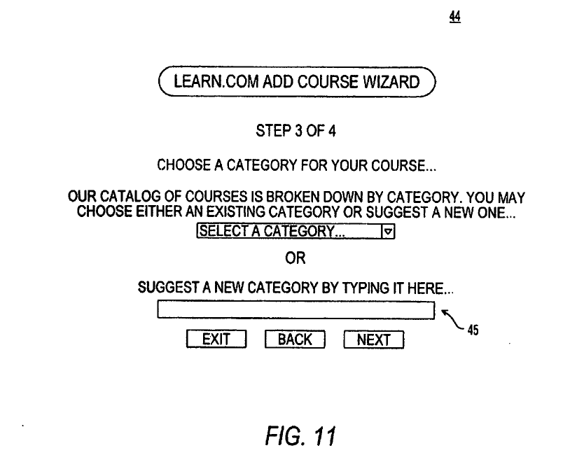

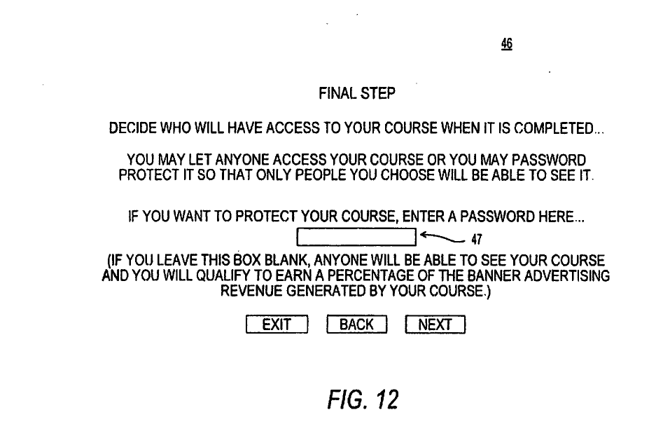

Once the author has read and agreed to these terms, he or she may begin writing a course by clicking on “go” button 36 shown on the bottom of FIG. 8. This may invoke an “Add Course Wizard” program that may prompt the author to name and describe the course, pick a category for the course, and decide who will have access to the final course document. For example, Course Wizard program 38 (FIG. 9) may provide a screen, such as screen 40 (FIG. 10), that includes a data entry field 42 in which the author may enter a suggested course name. Course Wizard Program 38 may also provide a screen 44 (FIG. 11) with a data entry field 45 so that the author may enter a suggested course category. Any course may be password protected for privacy, if desired (FIG. 12) by entering a password in a data entry field 47 of password screen 46. Such protection may prevent unauthorized access to the course by persons other than the author (or persons permitted by the author).

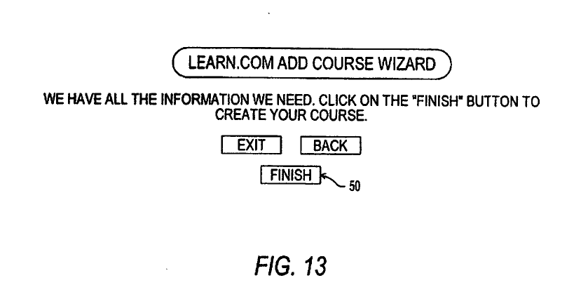

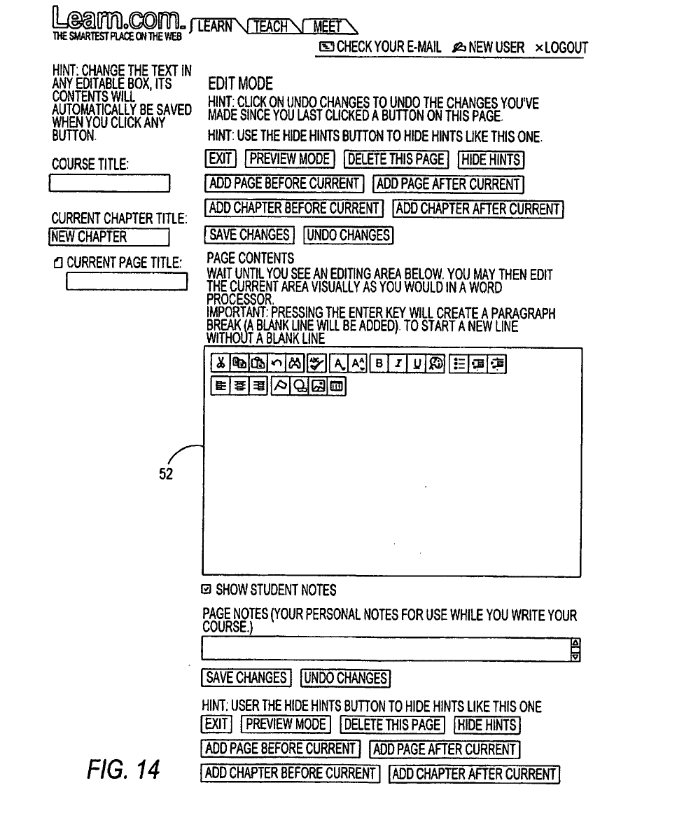

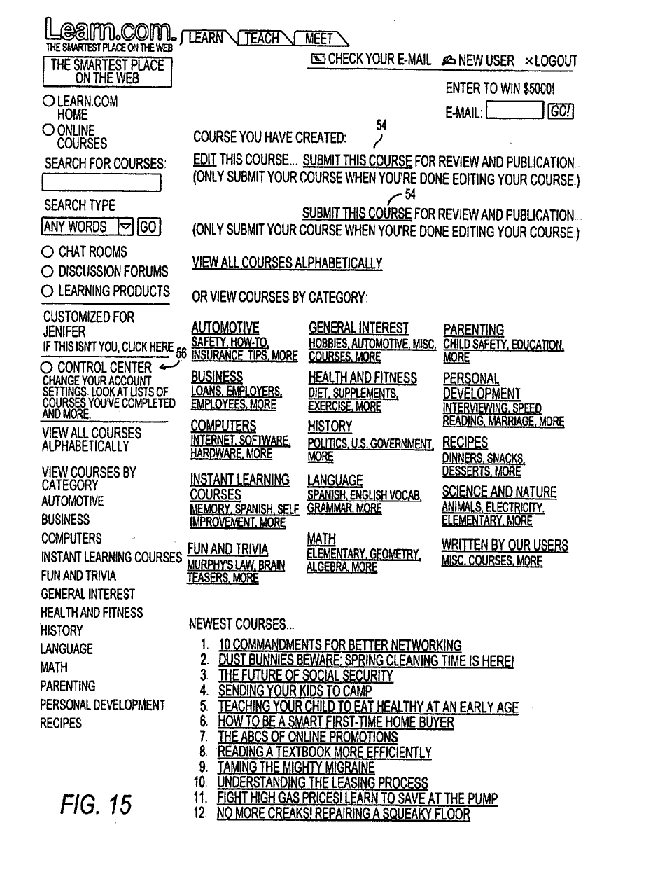

Next, Course Wizard program 38 may automatically install a small editing control program on the author's computer so that downloading the entire utility program is not required. Once all the information requested in FIGS. 9-12 is entered to the user's satisfaction, he or she may select a “Finish” button 50 (FIG. 13) that may create a course template and places the user in an “Edit Mode” screen 52 (FIG. 14). The author may now enter and edit course content into a text box using only a Web browser and the provided editing controls. When the author is satisfied with the course format and content, he or she may exit the course and submit it for review by the Web site's editorial staff. This may be done by selecting a “Submit the Course” link 54 shown in the top center portion of FIG. 15.

The submitted course may be reviewed and the authors notified as to whether their course has been selected for publication. If the course is approved for general publication, the author may receive a percentage of any advertising revenue generated by the course based on the number of page views. To keep track of course earnings, the author may access a private “Author's Control Center” 56 through the main Control Center on the proprietor's Web site that lists each course, the number of page views, and how much money the course has earned (as shown on the left hand side of FIG. 15). Based on accumulated earnings for all courses, the author may automatically receive a check or electronic money transfer each time the account reaches a predetermined minimum value.

Persons skilled in the art will appreciate that the present invention can be practiced by other than the describing embodiments, which are presented for purposes of illustration and not of limitation, and the present invention is limited only by the claims which follow.

1. A method for creating a computer-based instructional course that enables remotely-located author of the instructional course to receive revenue from the instructional course, the method comprising:
providing an interactive instructional course authoring program;
allowing the remotely-located author to create the instructional course with the authoring program;
providing the instructional course for use by remote users; and
supplying the author with revenue based on the number of users that view the instructional course.

2. The method of claim 1 wherein the providing the instructional course for use by remote users further comprises providing the instructional course on the Internet.

3. The method of claim 1 wherein the authoring program prompts the author to provide or select a category for the instructional course.

4. The method of claim 1 wherein the authoring program prompts the author to provide a description of the instructional course.

5. The method of claim 1 wherein the authoring program allows the author to password protect the instructional course so only parties with the password may edit or view the instructional course.

6. The method of claim 1 further comprising allowing the author to optionally post the instructional course to a web site such that a remote user may access and browse a plurality of instructional courses in a plurality of different categories and select a particular instructional course within a particular category for viewing wherein at least one of the plurality of browsed instructional courses is created using the authoring program.

7. A method for creating and distributing electronic documents, the method comprising:
creating a database containing a plurality of electronic documents, each of the electronic documents including information content relating to a particular topic or subtopic of an associated instruction course;
posting at least some of the plurality of electronic documents to a web site accessible by the general public;
arranging at least some of the plurality of electronic documents in a list by topic;
allowing a user to browse and select a particular electronic document from the list such that the user receives and is allowed to review content of at least some of the plurality of electronic documents relating to a selected topic.

8. The method of claim 7, wherein at least some of the plurality of electronic documents may be periodically reviewed and revised to include new content.

9. The method of claim 8, wherein at least some of the plurality of electronic documents are reviewed and revised by course authors.

10. The method of claim 7, wherein at least some of the plurality of electronic documents are created by selecting a desired template from a plurality of templates, and entering informational content into the desired template.

11. The method of claim 7, wherein the informational content is selected from the group consisting of digital text, images, sounds, video, animations, and graphics.

12. The method of claim 7, wherein at least some of the plurality of electronic documents are at least part of an instructional course.

13. A system for creating and distributing electronic documents, the system comprising:
a database containing a plurality of electronic documents, each of the electronic documents including information content relating to a particular topic or subtopic of an associated instructional course;
a publicly accessible web site including a plurality of links to at least some of the plurality of electronic documents in the database wherein the plurality of links are arranged in a list by topic; and wherein
a user may browse and select a particular electronic document from the list such that the user receives and is allowed to review content of at least some of the plurality of electronic documents relating to a selected topic.

14. The system of claim 13, wherein at least some of the plurality of electronic documents are periodically reviewed and revised to include new content.

15. The system of claim 14, wherein at least some of the plurality of electronic documents are reviewed and revised by course authors.

16. The system of claim 13, wherein at least some of the plurality of electronic documents are created by selecting a desired template from a plurality of templates, and entering informational content into the template.

17. The system of claim 13, wherein the informational content is selected from the group consisting of digital text, images, sounds, video, animations, and graphics.

18. The system of claim 13, wherein at least some of the plurality of electronic documents are at least part of an instructional course.

19. A method for permitting a remote user to take a computer-based instructional course, the method comprising:
allowing an author of the computer-based instructional course to post the instructional course on a publicly accessible web site such that the author of the instructional course operates substantially independent of an operator of the web site;
allowing the remote user to browse a plurality of categories of instructional courses available on the web site;
allowing the remote user to choose a particular category and browse the particular category and select a particular instructional course from a plurality of instructional courses within the particular category; and
allowing the remote user to view the selected instructional course.

20. The method of claim 19 wherein a plurality of different authors may post a plurality of different instructional courses on the web site such that a plurality of remote users can select to view content of at least one of the plurality of instructional courses.

21. The method claim 19, further supplying the author with revenue based on the number of users that view the instructional course.

22. A system for creating an educational course on a computer that enables an author of the educational course to receive revenue from the course, the system comprising:
an interactive instructional course authoring program, wherein a remotely-located author accesses the program and creates an instructional course;
a web page comprising a plurality of categories of instructional courses for use by remote users; and
a control center to supply the author with revenue based on the number of users that view the instructional course.

23. The system of claim 22 wherein the interactive instructional course authoring program is accessed on the Internet.

24. The system of claim 22 wherein the interactive instructional course authoring program prompts the author to provide or select a category for the instructional course.

25. The system of claim 22 wherein the interactive instructional course authoring program prompts the author to provide a description of the instructional course.

26. The system of claim 22 wherein the interactive instructional course authoring program allows the author to password protect the instructional course so only parties with the password may edit or view the instructional course.

27. The system of claim 22 wherein the instructional course is periodically reviewed and revised to include new content.

28. The system of claim 22 wherein the instructional course is reviewed and revised by course authors.

29. The system of claim 23 wherein the author revises the instructional course based on feedback presented in notes posted by remote users.
